(19) United States
(12) Patent Application Publication
(10) Pub. No.: US 2017/0332613 A1
(43) Pub. Date: Nov. 23, 2017

(54) Fishing Hook Employing Glass Compound

(71) Applicants: Brandon Graddy, Cape Coral, FL (US); Nicholas Carta, Bradley Beach, NJ (US)

(72) Inventors: Brandon Graddy, Cape Coral, FL (US); Nicholas Carta, Bradley Beach, NJ (US)

(21) Appl. No.: 15/598,365

(22) Filed: May 18, 2017

Related U.S. Application Data
(60) Provisional application No. 62/338,223, filed on May 18, 2016.

(51) Int. Cl. A01K 83/00; C03C 3/04

(52) U.S. Cl. CPC A01K 83/00; C03C 3/04

(57) ABSTRACT

A fishing hook device including a body with a barbed distal end and a looped proximal end. The body includes at least a portion constructed of glass including alkali aluminosilicate glass.

### BACKGROUND

### 1. Technical Field

Embodiments of the present invention pertain to fishing devices and, more specifically, to a fishing hook employing a glass compound.

### 2. Discussion of Related Art

Fishing is a large market worldwide, and in the United States generates approximately 15 billion dollars annually. There is always a demand for cutting edge products to enhance the performance of fishing gear and equipment, such as fishing hooks. Metal fishing hooks have traditionally been available, but other fishing hooks have been designed using plastic based materials to improve the metal fishing hooks. However, these designs are flawed due to the physical properties of plastic. For example, plastic based materials break when at the proper rigidity required for fishing hooks, and are too flexible at softer non-breaking levels.

### SUMMARY

A present invention embodiment pertains to a fishing hook comprising a body. The body includes a barbed distal end and a looped proximal end. At least a portion of the body is constructed of a glass type compound. When a portion of the hook is a glass compound, the remaining portions of the hook may be made of any materials (e.g., metal, plastic, the same glass compounds or other compounds, etc.) In addition, the hook may include a single glass compound or two or more different glass compounds.

### BRIEF DESCRIPTION OF THE DRAWINGS

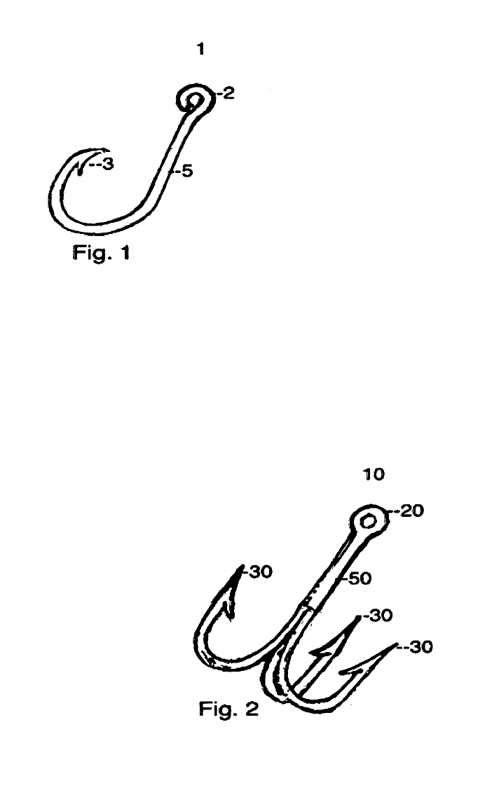

Generally, like reference numerals in the various figures are utilized to designate like components. FIG. 1 is a view in perspective of a fishing hook according to an embodiment of the present invention. FIG. 2 is a view in perspective of a fishing hook according to another embodiment of the present invention.

### DETAILED DESCRIPTION OF EXAMPLE EMBODIMENTS

Present invention embodiments pertain to fishing hooks employing an aluminosilicate or other chemically strengthened glass compound. These fishing hooks provide several advantages. For example, the fishing hooks provide reduced weight, and greater flexibility/strength, hardness, and immunity to corrosion. Aluminosilicate and other glass compounds are lighter in water than traditional metal fishing hooks. This gives the fishing hook of present invention embodiments more natural/realistic characteristics when attached to fishing line/lure, or hooked to live bait. Further, the fishing hooks of present invention embodiments provide less resistance/weight for bait fish while swimming which keeps the bait alive longer.

Aluminosilicate and other glass compounds have a higher bending strength than metal and plastic, thereby providing higher tolerances to instantly return to an original shape without breaking or losing any structural integrity. The glass compounds also embody physical qualities that make it harder than metal and plastic materials. This will allow for the sharp point of the hook to retain its shape and sharpness longer because it resists scratching and deforming, thereby yielding a product with a longer usable life. Moreover, the transparency of the glass compounds when submerged underwater enables the hook to be much less visible than metal hooks, which makes the fishing bait/lure seem much more realistic and natural to fish and other aquatic species. In addition, the glass compounds are completely immune to corrosion. This is in contrast to metal hooks which can rust and become useless after just one use, if not cleaned properly.

A fishing hook 1 according to an embodiment of the present invention is illustrated in FIG. 1. Specifically, fishing hook 1 comprises a generally T-shaped body 5 with a proximal looped end 2 that may be attached to a fishing line or fishing lure. Body 5 further comprises an arcuate, barbed distal end 3 opposite looped end 2 to receive various forms of bait and engage the fish or other aquatic species. Fishing hook 1 or any portion thereof (e.g., looped end, barbed end, any portion of the body, etc.) may be constructed of a glass compound.

A treble fishing hook 10 according to another embodiment of the present invention is illustrated in FIG. 2. Specifically, fishing hook 10 comprises a generally T-shaped body 50 with a proximal looped end 20 that may be attached to a fishing line or fishing lure. Body 50 further comprises three barbed, arcuate distal ends 30 opposite looped end 20 to receive various forms of bait and engage the fish or other aquatic species. Fishing hook 10 or any portion thereof (e.g., looped end, one or more barbed ends, any portion of the body, etc.) may be constructed of a glass compound. The fishing hooks of present invention embodiments employ glass compounds that have been strengthened through an ion exchange process, where alkali metal or other ions in the surface of the portions of the fishing hooks employing the glass compound are replaced by larger monovalent metal ions. Generally, the surface of the fishing hooks employing the glass compound is contacted with a source of the larger monovalent ions at an elevated temperature (below the strain point of the glass compound of the fishing hook) for a sufficient length of time to cause the replacement of small alkali metal ions in the fishing hook surface with the larger monovalent metal ions, thereby inducing a surface compression layer on the fishing hook.

In particular, the initial glass compound is preferably a form of glass having a regular basic soda lime glass composition. The initial glass compound undergoes a strengthening process employing a molten salt bath ion exchange technique to enable the glass compound to withstand increased pressure/resistance from breaking. The process includes placing the soda lime glass compound in a molten salt (sodium/potassium) bath for an approximate range of 2-96 hours at a temperature ranging from approximately 100C to approximately 800C which creates an environment in which ionic exchanges occur within the glass compound (e.g., sodium for ions to transfer deep inside the glass and potassium for the transfer of ions at the surface). Any desired type of ions may be added to the molten salt bath for exchange with the soda lime glass compound.

Once this process is completed, the glass compound is referred to as alkali aluminosilicate. The exchanged ions determine the beginning part of the compound name (e.g., lithium ions produce aluminosilicate, alkali ions produce alkali aluminosilicate, etc.). The glass compound is preferably an alkali aluminosilicate, but the initial glass compound may be strengthened by any desired ions and may use any glass compound depending upon the particular applications for the fishing hooks (e.g., weight or type of bait, type or temperature of water, etc.).

Glass compounds that undergo the strengthening process exhibit superior physical qualities for fishing compared to plastics and metals. These qualities include weight/buoyancy, flexibility/strength, hardness, and immunity to corrosion. Once the glass compound of the fishing hook is strengthened, the glass compound, when employed for the fishing hook distal end, undergoes a diamond edge sharpening process. The fishing hooks of present invention embodiments operate in generally the same manner as traditional metal or plastic fishing hooks. The fishing hooks of present invention embodiments may be attached to a fishing line and baited, or attached to a fishing lure.

It will be appreciated that the embodiments described above and illustrated in the drawings represent only a few of the many ways of implementing embodiments for fishing hooks employing a glass compound.

The glass compounds may be strengthened by any suitable ions, where the entire fishing hooks or any portion thereof may employ the strengthened glass compound. Further, the strengthening process may be applied to any initial glass compound.

Moreover, any suitable glass compound may be employed by present invention embodiments. The fishing hooks may include any configuration and/or shape. The fishing hooks may include any quantity of proximal ends with any type of configuration (e.g., looped, curved, linear, etc.) to secure a fishing or other line. The fishing hooks may include any quantity of distal ends with any type of configuration (e.g., arcuate, etc.) to secure a fishing lure, bait, and/or fish or aquatic species. One or more example claims summarizing aspects of a present invention embodiment are shown below.

1. A fishing device comprising:
a fishing hook comprising a body with a barbed distal end and a looped proximal end, wherein the body includes at least a portion constructed of a glass type compound.

2. The fishing device of claim 1, wherein the glass type compound includes aluminosilicate glass.

3. The fishing device of claim 2, wherein the glass type compound includes alkali aluminosilicate glass.
